(19) United States
(12) Patent Application Publication
(10) Pub. No.: US 2007/0159618 A1
(43) Pub. Date: Jul. 12, 2007

(54) SYSTEM AND METHOD FOR MEASURING ROTATIONAL SPEED OF AN OBJECT

(75) Inventors: Alan J. Woolfson, Milford, NH (US); Keith G. Wentworth, Merrimack, NH (US); Richard G. Peters, Nashua, NH (US)

Correspondence Address: MONARCH INSTRUMENT, 15 COLUMBIA DRIVE, AMHERST, NH, 03031, US

(73) Assignee: Monarch International Inc, Amherst, NH (US)

(21) Appl. No.: 11/608,910

(22) Filed: Dec. 11, 2006

Related U.S. Application Data
(63) Continuation of application No. 60/754,406, filed on Dec. 28, 2005.

(51) Int. Cl. G01P 3/36; G01J 1/00; G01T 1/00

(52) U.S. Cl. 356/27; 356/28; 250/336.1

(57) ABSTRACT

Disclosed are systems and methods for measuring rotational speed of an object rotating about a non-fixed axis of rotation. The system comprises a source unit capable of emitting source signal; a receiving unit capable of receiving the source signal synchronous with rate of rotation of the object; and a process and display unit communicatively coupled to the receiving unit, the process and display unit capable of determining and displaying rotational speed of the object.

### CROSS REFERENCE TO RELATED APPLICATION

This patent application is related to the U.S. Patent Application Ser. No. 60/754,406 filed on Dec. 28, 2005 and assigned to the assignee of the present invention.

### FIELD OF THE INVENTION

The present invention relates generally to systems and methods for measuring rotational speed of objects in real time, and, in particular to methods and systems for measuring rotational speed of objects having a non fixed axis of rotation in an environment including substantial variations in sound and light.

### BACKGROUND OF THE INVENTION

Skating is a sport where a skater has to slide over the ice and similar smooth surfaces for performing the various skills. Generally, it has been seen that most of the skaters spin or rotate while performing. The spinning or rotation is considered as one of the most important skills that may be performed by a skater; and the skaters may be interested to know their rotational speed in real time. Another difficulty is that the event may be occurring in an environment that including substantial variations in sound and light. There are some conventional systems for measuring the rotational speed of a rotating body. Such conventional systems are not capable of effectively measuring the rotational speed of an object rotating about a non-fixed axis of rotation, for example, rotational speed of a skater.

Accordingly, there is a need for a system that can measure the real time rotational speed of an object rotating about a non fixed axis of rotation in an easy and effective manner in an environment including substantial variations in sound and light.

### SUMMARY OF THE INVENTION

In view of the foregoing disadvantages inherent in the prior arts, the general purpose of the present invention is to provide a system and method for measuring rotational speed of an object configured to include all the advantages of the prior art, and to overcome the drawbacks of the prior art.

In one aspect, the present invention provides a system for measuring rotational speed of an object rotating about a non-fixed axis of rotation. The system comprises a source unit capable of emitting source signal; a receiving unit capable of receiving the source signal synchronous with rate of rotation of the object; and a process and display unit communicatively coupled to the receiving unit, the process and display unit capable of determining and displaying rotational speed of the object.

In another aspect, the present invention provides a method for measuring rotational speed of an object rotating about a non-fixed axis of rotation. The method comprises generating a source signal, the source signal having a first frequency component, and a second frequency component having lower frequency than the first frequency component; detecting the source signal synchronous with the rate of rotation of the object by verifying the presence of the first frequency component; filtering the source signal to remove the first frequency component; and determining a time difference between start rise/fall times for each set of two consecutive pulse groups of the second frequency component in a spin interval for measuring the rotational speed of the object.

In another aspect, the present invention provides a method for measuring rotational speed of an object rotating about a non-fixed axis of rotation. The method comprises generating a source signal; reflecting the source signal using a reflective medium attached to the object; detecting the source signal synchronous with the rate of rotation of the object; and determining a time difference between start rise/fall times for each set of two consecutive pulse groups of the source signal in a spin interval for measuring the rotational speed of the object.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a block diagram of a system 100 for measuring rotational speed of an object, according to an embodiment of the present invention;

FIG. 2A illustrates a modulated electromagnetic signal, according to an embodiment of the present invention;

FIG. 2B illustrates a demodulated electromagnetic signal, according to an embodiment of the present invention;

FIG. 3 illustrates the system 100 in a utilized state, according to an embodiment of the present invention;

FIG. 4 is a flowchart showing the steps involved in the functioning of the system 100, according to an embodiment of the present invention;

FIG. 5 is a block diagram of a system 500 for measuring rotational speed of an object, according to another embodiment of the present invention;

FIG. 6 illustrates system 500 in a utilized state, according to an embodiment of the present invention; and

FIG. 7 is a flowchart showing the steps involved in the functioning of the system 500, according to an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular system and method for measuring rotational speed of an object, as shown and described. It is understood that various omissions, substitutions of equivalents are contemplated as circumstances may suggest or render expedient, but is intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a system for measuring and monitoring rotational speed of an object. More specifically, the system may be used for measuring and monitoring the rotational speed of an object rotating about a non-fixed axis of rotation. The system is capable of functioning in environments having a plurality of sound and light sources, i.e., environments involving electromagnetic signals of different frequencies. For example, the system may be used to calculate rotational speed of a skater performing at places having a plurality of sound and light sources. The system may be used as a device for judging the talent of the performing skaters.

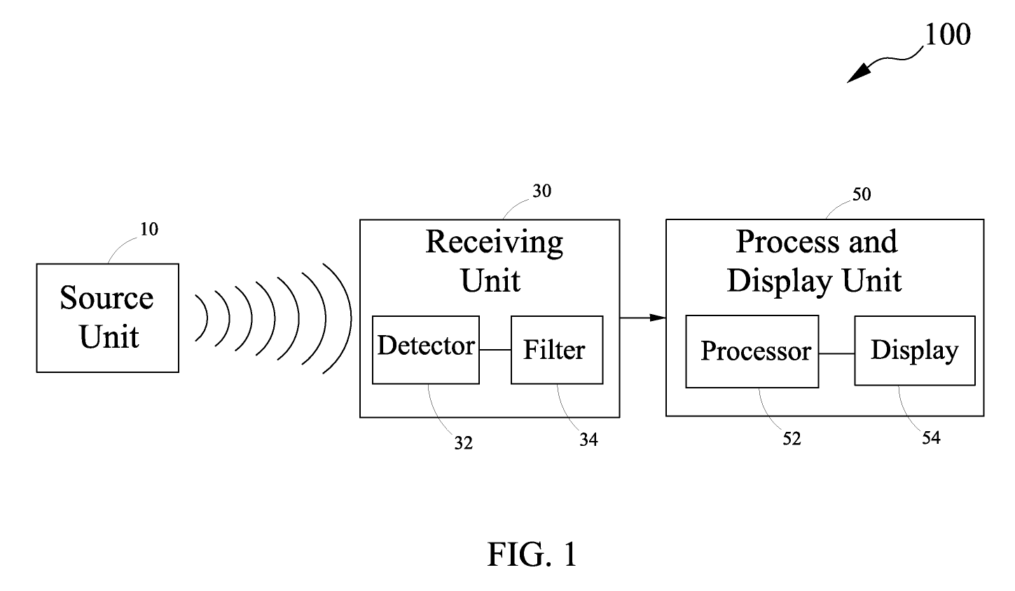

Referring to FIG. 1, a block diagram of a system 100 for measuring rotational speed of an object, is shown. The system 100 comprises a source unit 10, a receiving unit 30, and a process and display unit 50 communicatively coupled to the receiving unit 30.

The source unit 10 is a source of electromagnetic energy capable of emitting electromagnetic signals, hereinafter, collectively referred to as ‘source signal’. The source signal may include infra-red signal, laser signal, and the like. The source unit 10 comprises a power supply component (for example, a set of batteries) for powering the source unit 10 for emitting electromagnetic signals.

The source signal may be modulated at a specific frequency or at a group of specific frequencies, such that, the receiving unit 30 may distinguish the source signal from other electromagnetic signals generated from other sources in the same environment. For modulation, the source unit 10, in one example, may comprise an infra-red LED that emits modulated infra-red signals. More specifically, the source unit 10 may comprise a micro-controller for modulating the infra-red LED, and a transistor for powering on/off the infra-red LED for creating modulated infra-red signals.

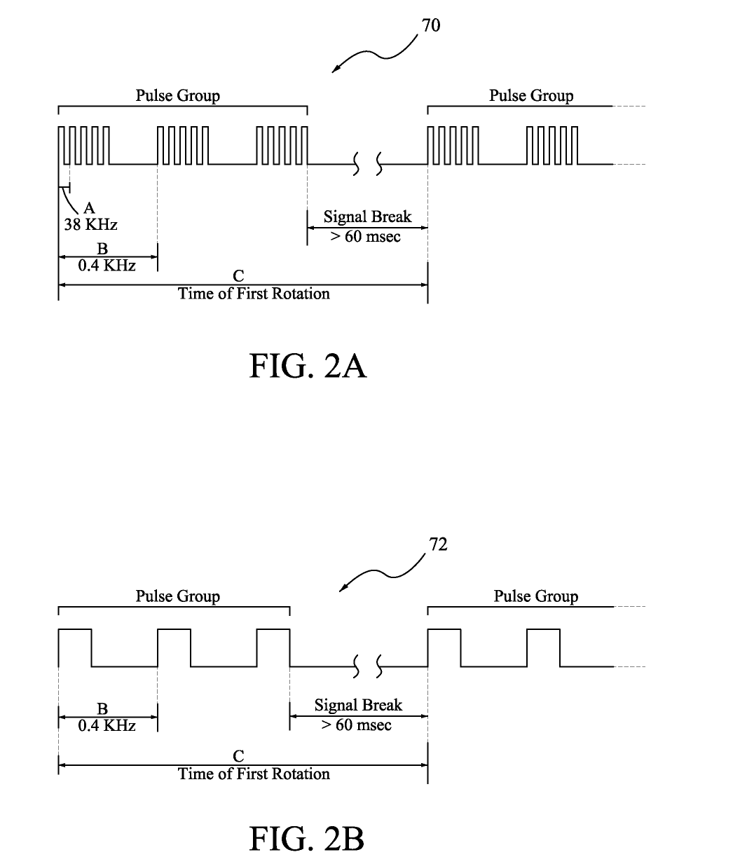

As shown in FIG. 2A, in one embodiment, the source signal (represented as 70) is modulated at a first frequency component A (for example, a higher frequency component of 38 kHz) and a second frequency component B (for example, a lower frequency component of 0.4 KHz). The first frequency component A (38 KHz) provides means for identification of the source signal by the receiving unit 30; while the signal breaks between the second frequency component B (0.4 KHz) provides means for time calculation for measuring the rotational speed of the object, performed by the process and display unit 50.

The receiving unit 30 is capable of receiving the source signal synchronous with rate of rotation of the object. The receiving unit 30 has a detector 32 for correctly detecting the source signal in environments involving electromagnetic signals of different frequencies. For example, in case of the source signal being an infra red signal, the detector 32 may be a photo detector optimized for infra red signal detection with an inbuilt lens filter (not shown) to exclude non-infra red signal.

The receiving unit 30 further has a filter 34 (i.e., a low pass filter 34) capable of demodulating the source signal. More specifically, the low pass filter 34 is capable of removing the higher frequency component, i.e., the first frequency component A (38 KHz) from the source signal (i.e., from the signal 70).On demodulation, as shown in FIG. 2B, the source signal (represented as signal 72) only has the lower frequency component, i.e., the second frequency component B (0.4 KHz).

On demodulation, the source signal is passed on to the process and display unit 50 for measuring the rotational speed of the object. More specifically, the process and display unit 50 has a processor 52 with measurement software for calculating the rotational speed of the object, and a display 54 for displaying the calculated rotational speed of the object. The processor 52 may be a microcontroller, for example, an integrated chip that may have all components of a controller, i.e., a central processing unit (CPU), a random access memory (RAM), a read only memory (ROM), input/output interfaces, and a timer. The display 54 may include a liquid crystal display, an organic light emitting display, a field emission display, and the like.

The receiving unit 30 and the process and display unit 50 may be housed in a single enclosure having a common power supply component (a set of batteries) for powering the receiving unit 30 and the process and display unit 50.

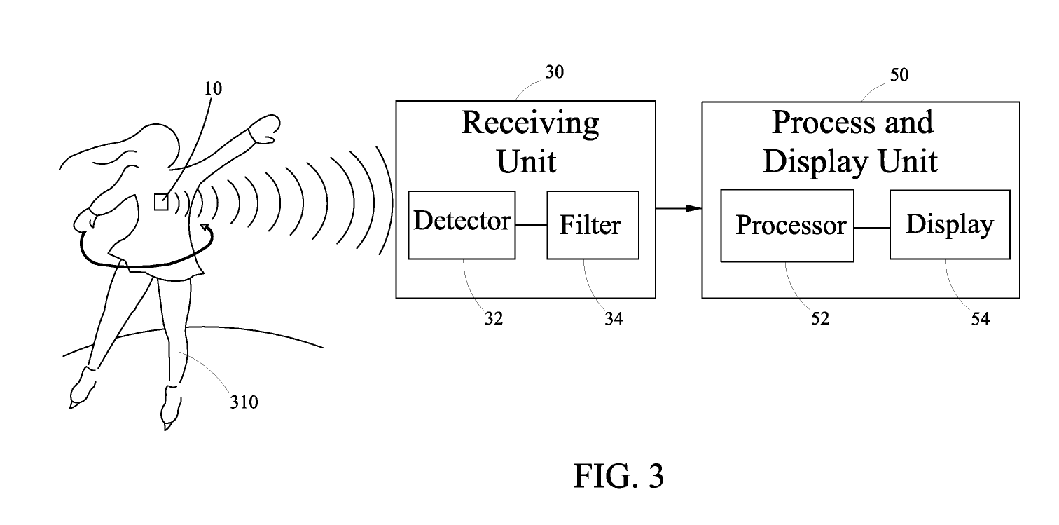

In a utilized state of the system 100, the source unit 10 is attached to the object. For example, as shown in FIG. 3, the source unit 10 is attached to a convenient portion of a skater 310 using suitable attachment means, such as, waist strap, and the like. The attachment may be done in a manner, such that, the source unit 10 does not get covered by the clothes of the skater 310, while rotating. The receiving unit 30 receives the source signal synchronous with the rate of rotation of the skater, enabling the process and display unit 50 to calculate the rotational speed of the skater 310. More specifically, the receiving unit 30 receives the source signal from the source unit 10 for a period wherein the source unit 10 faces the receiving unit 30, and the receiving unit 30 does not receive any source signal when the skater 310 rotates away, such that, the source unit 10 no longer faces the receiving unit 30.

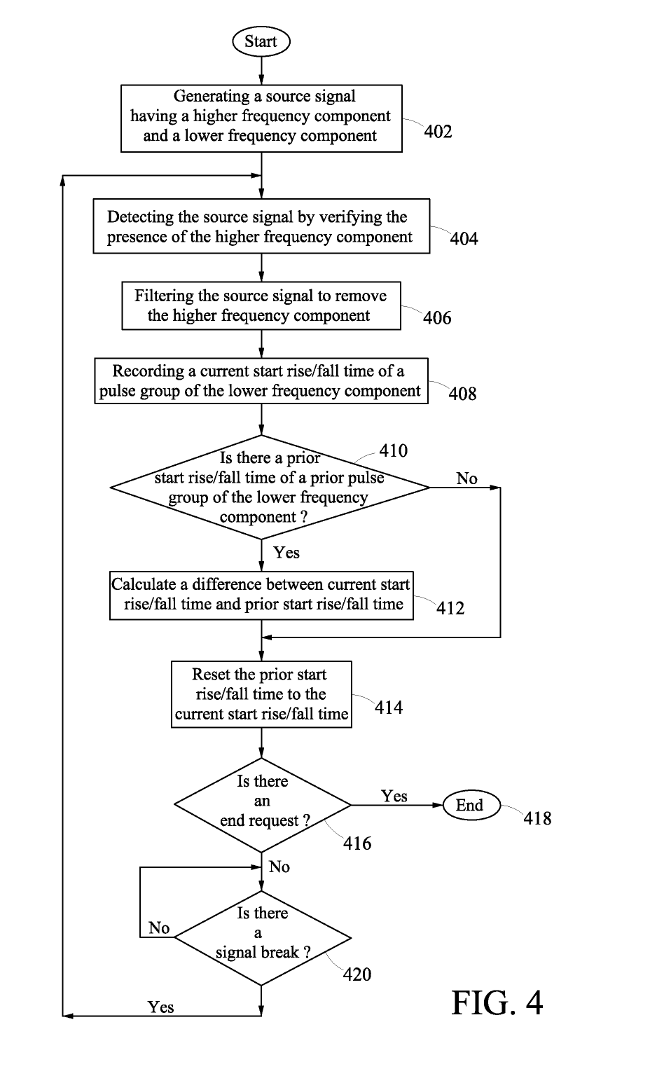

Referring to FIG. 4, a flowchart is provided, illustrating a method for measuring the rotational speed of an object (for example, the skater 310) rotating about a non-fixed axis of rotation, using the system 100. The method begins at step 402 comprising, generating a source signal, using the source unit 10. The source signal is a modulated source signal having a first frequency component A (i.e., higher frequency component of 38 KHz) and the second frequency component B (i.e., lower frequency component of 0.4 KHz). At step 404, the receiving unit 30 correctly detects the source signal by verifying the presence of the first frequency component A (38 KHz). Next, at step 406, the source signal is filtered (i.e., passed through the low pass filter 34) to remove the first frequency component A (38 KHz), i.e., demodulation of the source signal to provide a source signal having only the second frequency component B (0.4 KHz).

Next, the processor 52 records the start rise/fall time of pulse groups of the second frequency component B. Upon receiving the source signal, the processor 52 identifies a pulse group of the second frequency component B and identifies the next pulse group of the second frequency component B only after a predetermined time period. For example, the processor 52 identifies a first pulse group and then identifies the next pulse group only after 60 milliseconds, i.e. any pulse group that occur less than 60 milliseconds after the first pulse group is ignored.

More specifically, at step 408, the processor 52 records a current start rise/fall time of a pulse of the second frequency component B (0.4 KHz). Next, the decision step 410 determines whether there is a prior start rise/fall time of a prior pulse group of the second frequency component B (0.4 KHz). If there is no prior start rise/fall time, the system goes ahead to step 414. On determining a prior start rise/fall time, the processor 52, calculates a time difference C between the current start rise/fall time and the prior start rise/fall time, at step 412. The time difference C is the difference in time from the start of one pulse group to the start of the next pulse group of the second frequency component B (0.4 KHz), i.e., difference in time between consecutive pulse groups of the second frequency component B (0.4 KHz). Referring to FIG. 2B, the time difference C and the pulse groups are illustrated. At step 414, the processor 52 resets the value of the prior start rise/fall time to the current start rise/fall time. Next, the decision step 416 determines whether the system 100 has been requested to end. If requested to end, the rotational speed measuring system 100 ends at step 418. Alternatively, the system 100 looks for a break in the source signal at decision step 420. On finding a break in the source signal, the system 100 goes back to step 404, and repeats the steps for calculating another time difference C of the second frequency component B (0.4 KHz).

Each time difference C indicates the time for one rotation, since there is one pulse group or one signal break for every rotation. The rotational speed is calculated using the time difference C. For example, the rotational speed in rotations per minute may be calculated using the formula:

$$Rotations per minute = \frac{60}{C ( in seconds )}$$

The time differences C between each set of two consecutive pulse groups of the second frequency component B (0.4 Hz) in a spin interval may be used to calculate an average rotational speed of the object in the spin interval. As used herein, a ‘spin interval’ refers to a time period having at least one rotation of the object. For the spin interval, the system 100 may further determine highest rotational speed in the spin interval; length of time of the spin interval; and number of rotations during the spin interval.

In embodiments, wherein the source signal comprises only one frequency component, all the steps excluding step 406 are performed. The method comprises generation of source signal having one frequency component; correct detection of the source signal by verifying the presence of the frequency component; and determination of time difference between consecutive pulse groups of the frequency component of the source signal for measuring the rotational speed of the object.

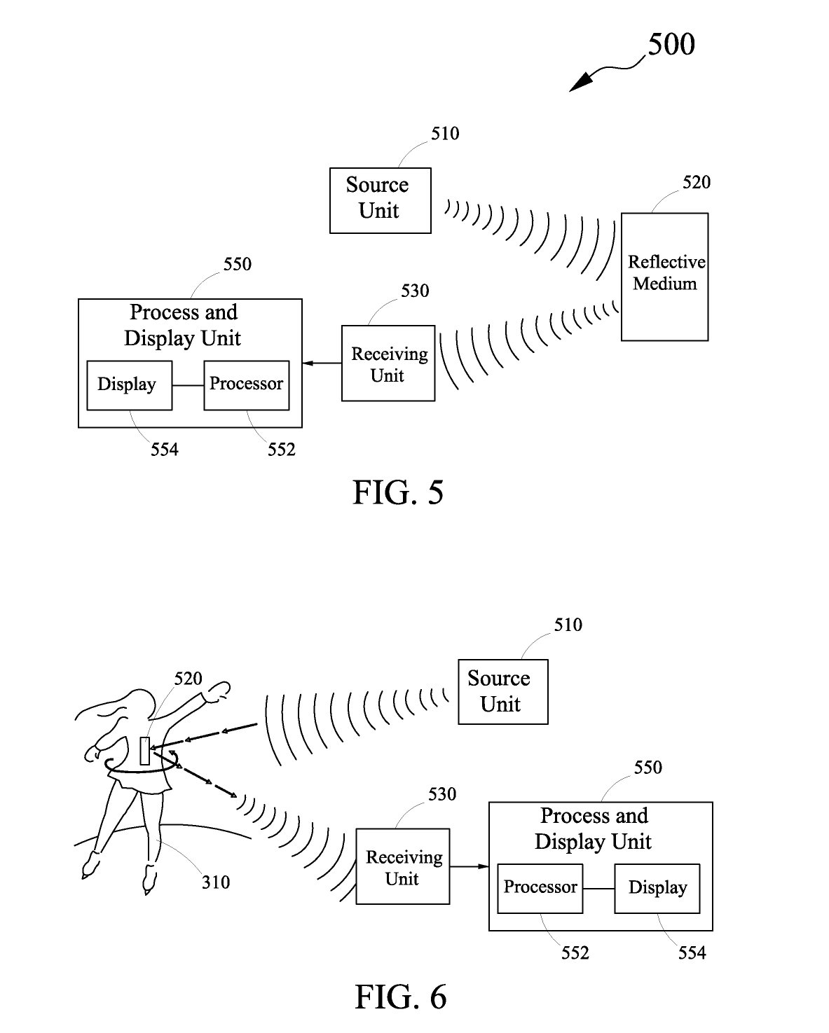

Referring to FIG. 5, in another embodiment, a block diagram of a system 500 for measuring rotational speed of an object is shown. The rotational speed measuring system 500 comprises a source unit 510, a reflective medium 520, a receiving unit 530, and a process and display unit 550 communicatively coupled to the receiving unit 530.

The source unit 510 is a source of electromagnetic energy capable of emitting wide angled electromagnetic signals in a horizontal plane, hereinafter collectively referred to as ‘source signal’. For example, the source unit 510 may be a laser diode capable of emitting laser signals passing through a lens to produce a horizontal line. The source unit 510 has a power supply component (for example, a set of batteries) for powering the source unit 510. The source unit 510 may further comprise an on/off power switch for switching on/off the source unit 510.

The reflective medium 520 is capable of reflecting the source signal emitted by the source unit 510, once the emitted source signal reaches the reflective medium 520. The reflective medium may be a stock reflective tape strip or reflective paint strip coupled to an object, for example, the skater 310. The reflective medium 520 may have a shape and size that provides a sufficient reflecting surface to the incident source signal. For example, when attached to the skater 310, the reflective medium 520 may have a width of about 0.5 inch and a vertical length of about 12 inches.

The receiving unit 530 detects the reflected source signal in environments involving various sources of electromagnetic energy.

The process and display unit 550 has a processor 552 with measurement software for calculating the rotational speed of an object, and a display 554 for displaying the calculated rotational speed of the object. The processor 552 may be a microcontroller, for example, an integrated chip that may have all components of a controller, i.e., a central processing unit (CPU), a random access memory (RAM), a read only memory (ROM), input/output interfaces, and a timer. The display 554 may include a liquid crystal display, an organic light emitting display, a field emission display, and the like. The receiving unit 530 and the process and display unit 550 may be housed in a single enclosure having a common power supply (for example, a set of batteries) for powering the receiving unit 530 and the process and display unit 550. The source unit 510 may be housed in the same enclosure.

Referring to FIG. 6, the system 500 is shown in a utilized state. The reflective medium 520 should be coupled in a manner, such that, the reflective medium 520 does not get covered by the clothes and/or body parts of the skater 510, while rotating. The source unit 510 and the receiving unit 530 fixed to a convenient position, such that, the source unit 510 and the receiving unit 530 may closely track the skaters reflective medium 520 as the skater's axis of rotation may move during the rotations. The receiving unit 530 receives the source signal from the source unit 510 for a period wherein the reflective medium 520 reflects the source signal and the receiving unit 530 faces those reflected source signal.

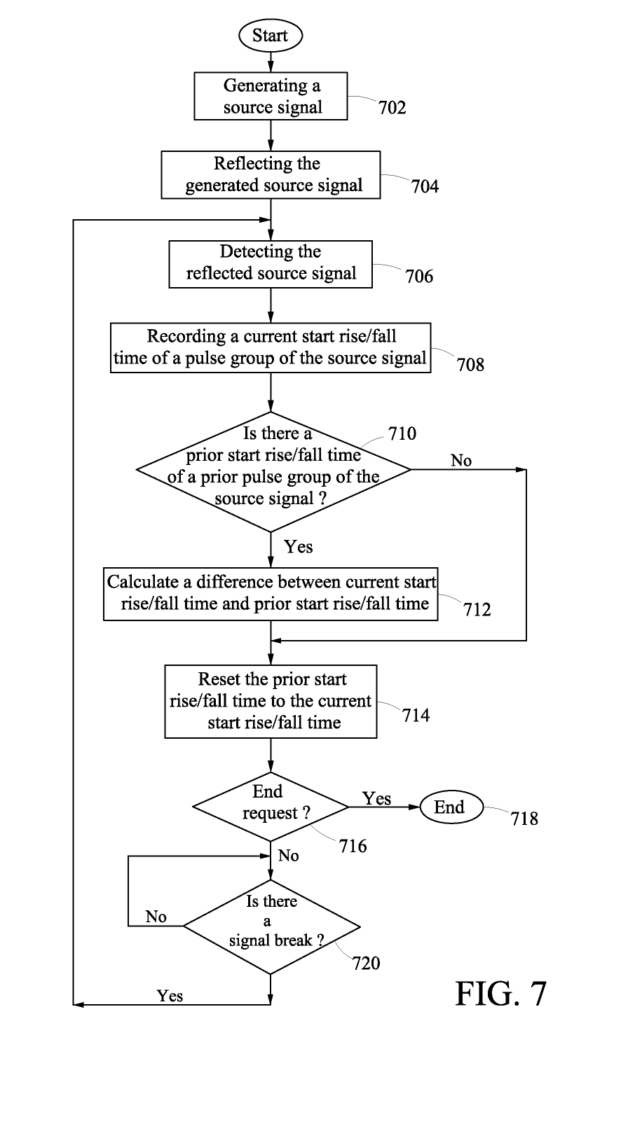

Referring to FIG. 7, a flowchart is provided illustrating a method for measurement of rotational speed of an object (for example, the skater 310) rotating about a non-fixed axis of rotation, using the system 500. The method begins at step 702, comprising, generating a source signal using the source unit 510. The generated source signal is reflected by the reflective medium 520 attached to the skater 310, as shown at step 704. At step 706, the receiver unit 530 correctly detects the reflected source signal.

Next, the processor 552 determines the start rise/fall times of pulse groups of the source signal. Upon receiving the source signal, the processor 52 identifies a pulse group of the frequency component B and identifies the next pulse group of the frequency component B only after a predetermined time period. For example, the processor 52 identifies a first pulse group and then identifies the next pulse group only after 60 milliseconds, i.e. any pulse group that occurs in less than 60 milliseconds after the first pulse group is ignored. At step 708, the processor 552 records a current start rise/fall time of a pulse group of the source signal. Next, the decision step 710 determines the presence of a prior start rise/fall time of a prior pulse group of the source signal. If a prior start rise/fall time is not found, the rotational speed measuring system 500 goes ahead to step714. On finding a prior start rise/fall time, the processor 552 calculates a time difference D between the current start rise/fall time and the prior start rise/fall time, at step 712. The time difference D is the difference in time from the start of one pulse group to the start of the next pulse group of the source signal, i.e., difference in time between consecutive pulse groups of the source signal. The processor 552 resets the value of the prior start rise/fall time to the current start rise/fall time, at step 714. Next, the decision step 716 determines whether the system 500 has been requested to end. If requested to end, the system 500 ends at step 718. Alternatively, the system 500 looks for a break in the source signal at decision step 720. On finding a break in the source signal, the system 500 goes back to step 706 and repeats the steps for calculating another time difference D of the source signal.

Each time difference D indicates the time for one rotation, since there is one pulse group or one signal break for every rotation. The rotational speed is calculated using the time difference D. For example, the rotational speed in rotations per minute may be calculated using the formula:

$$Rotations per minute = \frac{60}{D ( in seconds )}$$

The time differences D between each set of two consecutive pulse groups of the source signal in a spin interval may be used to calculate an average rotational speed of the object in the spin interval. For the spin interval, the system 500 may further determine highest rotational speed in the spin interval; length of time of the spin interval; and number of rotations during the spin interval.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

1. A system for measuring rotational speed of an object rotating about a non-fixed axis of rotation, comprising:
a source unit capable of emitting a source signal;
a receiving unit capable of receiving the source signal synchronous with rate of rotation of the object;
a process and display unit communicatively coupled to the receiving unit, the process and display unit capable of determining and displaying rotational speed of the object.

2. The system of claim 1, wherein the object is a skater.

3. The system of claim 1, wherein the source signal is an infra-red signal or laser signal.

4. The system of claim 1, wherein the receiving unit comprises a detector with an inbuilt filter for correctly detecting the source signal.

5. The system of claim 1, wherein the source unit is attached to the object.

6. The system of claim 5, wherein the source signal comprises a first frequency component, and a second frequency component having lower frequency than the first frequency component.

7. The system of claim 6, wherein the receiving unit comprises a filter capable of removing the first frequency component from the source signal before the source signal is passed onto the process and display unit.

8. The system of claim 1, further comprising a reflective medium attached to the object for reflecting the source signal to the receiving unit.

9. The system of claim 8, wherein the reflective medium comprises at least one of reflective tape strip and reflective paint strip.

10. The system of claim 1, wherein the rotational speed of the object is an average rotational speed of the object in a spin interval.

11. The system of claim 10, wherein the process and display unit further determines and displays at least one of highest rotational speed in a spin interval, length of time of the spin interval, and the number of rotations during the spin interval.

12. A method for measuring rotational speed of an object rotating about a non-fixed axis of rotation, comprising:
generating a source signal, the source signal having a first frequency component, and a second frequency component having lower frequency than the first frequency component;
detecting the source signal synchronous with the rate of rotation of the object by verifying the presence of the first frequency component;
filtering the source signal to remove the first frequency component; and
determining a time difference between start rise/fall times for each set of two consecutive pulse groups of the second frequency component in a spin interval for measuring the rotational speed of the object.

13. The method of claim 12, wherein the source signal is generated by a source unit attached to the object.

14. The method of claim 12, wherein the source signal is infra red signal.

15. The method of claim 12, wherein the rotational speed of the object is an average rotational speed of the object in a spin interval.

16. The method of claim 12, further comprising determining at least one of highest rotational speed in a spin interval, length of time of the spin interval, and the number of rotation during the spin interval.

17. A method for measuring rotational speed of an object rotating about a non-fixed axis of rotation, comprising:
generating a source signal;
reflecting the source signal using a reflective medium attached to the object;
detecting the reflected source signal synchronous with the rate of rotation of the object; and
determining a time difference between start rise/fall times for each set of two consecutive pulse groups of the source signal in a spin interval for measuring the rotational speed of the object.

18. The method of claim 17, wherein the source signal is laser signal.

19. The method of claim 17, wherein the rotational speed of the object is an average rotational speed of the object in a spin interval.

20. The method of claim 17, further comprising determining at least one of highest rotational speed in a spin interval, length of time of the spin interval, and the number of rotation during the spin interval.
